(19) United States
(12) Patent Application Publication
(10) Pub. No.: US 2015/0046085 A1
(43) Pub. Date: Feb. 12, 2015

(54) Alternative routing determination

(71) Applicant: Google Inc., (US)

(72) Inventor: Michal Gornisiewicz, Zurich (CH)

(73) Assignee: Google Inc., Mountain View, CA (US)

(21) Appl. No.: 13/869,321

(22) Filed: Apr. 24, 2013

(51) Int. Cl. G01C 21/00

(52) U.S. Cl. CPC G01C 21/00
USPC 701/519

(57) ABSTRACT

A computer implemented method, system and apparatus for routing a user from a starting location to a destination location. The method comprises routing the user towards the destination along an initial route, prompting the user that an alternative route to the destination is available and monitoring the location of the user to determine whether to provide routing directions for the initial route or for the alternative route.

### FIELD

The invention relates to providing a route between geographical locations.

### BACKGROUND

Travelling between locations generally involves selecting the most appropriate route for the journey. If an electronic device is used to provide route instructions, a user may preselect his or her desired route from multiple route options by inputting a touch command to the device before beginning the journey.

### SUMMARY

In embodiments, a computer implemented method of routing a user to a destination comprises routing the user towards the destination along an initial route; prompting the user that an alternative route to the destination is available; and monitoring the location of the user to determine whether to provide routing directions for the initial route or for the alternative route.

In embodiments, an apparatus comprises at least one computer processor and at least one computer memory storing computer readable instructions which when executed by the at least one processor cause the apparatus to route a user towards a destination along an initial route, prompt the user that an alternative route to the destination is available and monitor the location of the user to determine whether to provide routing directions for the initial route or for the alternative route.

In embodiments, an apparatus comprises a route provider which is configured to route a user from a starting location to a destination location by routing the user towards the destination along an initial route, prompting the user that an alternative route to the destination is available and monitoring the location of the user to determine whether to provide routing directions for the initial route or for the alternative route.

In embodiments, a system for routing a user from a starting location to a destination location comprises at least one computer processor and at least one computer memory storing computer readable code which when executed by the at least one processor causes the system to route the user towards the destination along an initial route, prompt the user that an alternative route to the destination is available and monitor the location of the user to determine whether to provide routing directions for the initial route or for the alternative route.

In embodiments, a computer program product comprises computer readable instructions which when executed by at least one computer processor cause an apparatus to issue user instructions to route a user from a starting location to a destination location by routing the user towards the destination along an initial route, prompting the user that an alternative route to the destination is available and monitoring the location of the user to determine whether to provide routing directions for the initial route or for the alternative route.

### BRIEF DESCRIPTION OF THE FIGURES

In order that the invention may be more fully understood, and for the purposes of example only, embodiments of the invention are described below with reference to the accompanying figures in which:

FIG. 1 is a schematic diagram of a system for providing alternative routes between geographical locations;

FIG. 2 is a schematic illustration of an electronic device which is configured to output routing instructions for a route between geographical locations;

FIG. 3 is a schematic diagram of a plurality of electronic apparatuses which are communicatively coupled together by a communication coupling such as the Internet in order to route a user to a geographical destination;

FIG. 4 is a schematic diagram of an electronic user device which is configured to output prompts and routing instructions concerning alternative routes to a geographical destination; and

FIG. 5 is a flow diagram of a method of automatically routing a user to a geographical destination via one or more alternative routes.

### DETAILED DESCRIPTION

### Overview

A plurality of different routes to a destination are offered and a determination is automatically made as to which of the different routes is being followed by monitoring a location of the follower. Routing directions are provided for the route which has been determined as the one which is being followed. The location of the follower may be determined by monitoring the location of an electronic device associated with the follower.

### System Architecture and Method

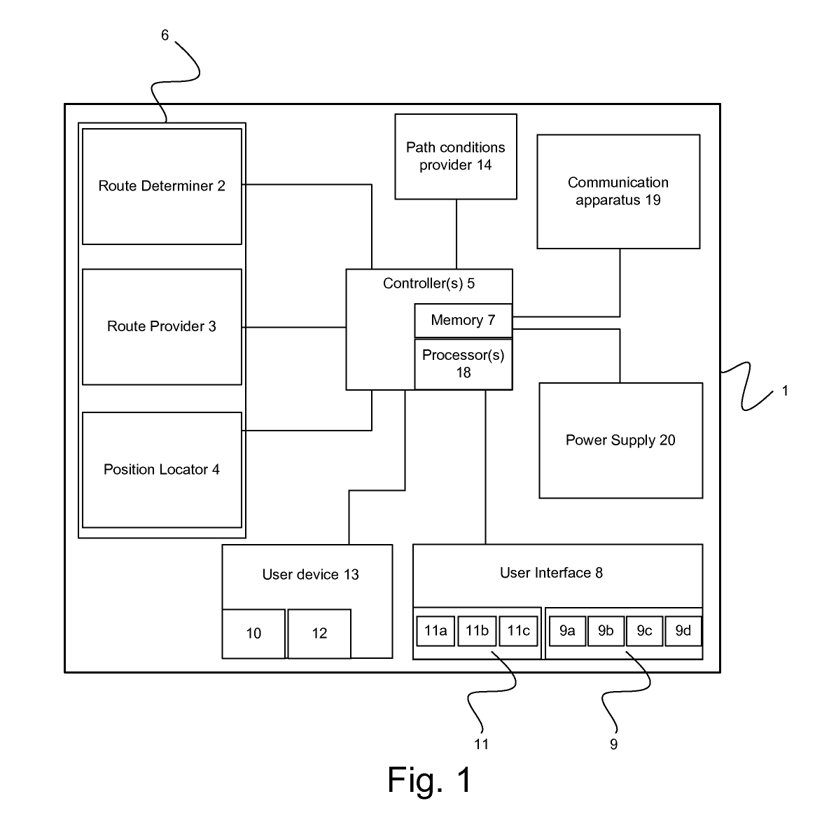

A system 1 for providing routes is illustrated in FIG. 1. A route provided by the system 1 can be followed in order to travel between a plurality of geographical locations on the route.

As shown in FIG. 1, the system 1 comprises a route determiner 2 and a route provider 3. The route determiner 2 is configured to determine routes between geographical locations and the route provider 3 is configured to cause the determined routes to be provided to a user of the system 1. The system 1 also comprises a location provider 4, which is configured to monitor the geographical location of the user of the system 1. User location information provided by the location provider 4 may be used by the route determiner 2 to determine appropriate routes and by the route provider 3 to provide appropriate routing instructions to the user. The route determiner 2, route provider 3 and location provider 4 may each be embodied in software, for example as one or more application programs which run in a controller 5 of the system 1, or in system hardware. Optionally, one or more of the route determiner 2, the route provider 3 and the location provider 4 may be embodied together as a route determining and providing module 6, either in software or hardware.

The route determiner 2 is configured to determine an initial route to a geographical destination and also to determine one or more alternative routes to the same destination. For example, as explained below, the route determiner 2 may determine an initial route to a geographical destination before subsequently determining alternative routes which branch off from the initial route.

The alternative routes may direct the user to the same destination as the initial route, but may be determined using updated information about the available route network and/or may be determined based on different, or differently-weighted, selection criteria to the initial route. For example, the alternative routes may direct the user away from heavy traffic present on the initial route or may direct the user along more scenic roads and/or paths than those included in the initial route. The alternative routes may also avoid (or include) toll roads and/or highways which may be part (or not part) of the initial route. It will be appreciated that there are many criteria upon which the initial and alternative routes may be determined and that the configuration of these criteria could be adjusted in order to affect the determination of the initial and alternative routes by the route determiner 2.

To give an example, the route determiner 2 may be configured to initially determine the route which offers the fastest journey between a specified starting location and a destination. The starting location may be the user's current location, for example as provided by the location provider 4, or may be an otherwise specified location. In order to determine the fastest route between the starting location and the destination, the route determiner 2 may be configured to obtain map data from a computer readable memory 7 of the system 1. The map data includes path data, which describes the network of available paths located in the geographical vicinities of the starting location and the destination and the geographical region therebetween. The types of path in the path network may include, for example, one or more of roads, pavements, sidewalks, cycle paths, cycling trails, walking trails, skiing trails and off-road tracks. The map data may be configurable so that the user is able to restrict the paths to those which are suitable for the vehicle or method of transport which he/she is planning to use. A suitable routing algorithm, such as one based on Dijkstra's algorithm, may be run in the route determiner 2 to determine routes from the available path network.

In addition to the available path network, the route determiner 2 uses other factors to determine the fastest route. An example is information about traffic on the path network, such as the amount of traffic on the available paths, the speed at which the traffic is travelling and/or the availability to overtake the traffic. The route determiner 2 takes this information into account, along with the lengths of the available routes and other information such as the number of turnings and/or hazards, in order to determine which of the routes is the fastest. The way in which the route determiner 2 collects this information will be explained further below. It will be understood that, in addition or as an alternative to the information referred to above, other factors could also be taken into account.

Although the determination of the initial route is described above in terms of determination of a fastest route, it will be appreciated that the description is equally applicable to determining the initial route in accordance with other factors such as the desire to avoid tolls or highways or the desire for the route to be scenic or otherwise enjoyable or easy to follow.

The route determiner 2 may be configured to determine the initial route in response to receipt of a route request, which specifies at least the geographical destination required for the route. The route request may also specify other locations which are to be included on the route, such as the starting location and one or more locations through which the route should pass before arriving at the destination. The route request may also specify other preferred criteria for the route, such as any of the factors discussed above.

The route request may, for example, be initiated by the user by inputting instructions to a user interface 8 of the system 1. The input instructions may specify or otherwise indicate parameters for the requested route, such as the starting and/or finishing locations, which may be used by the system 1 to generate a route request. As explained below, the user interface 8 may comprise input transducers 9 through which such instructions can be entered. The controller 5 of the system 1 may be configured to interpret the instructions input by the user and to create a route request which is readable by the route determiner 2. Alternatively, the route request may be received from an electronic apparatus 10 or software application 10 which is outside the system 1. Such an external route request may be forwarded directly to the route determiner 2 or may be re-formatted or otherwise manipulated by the controller 5 beforehand in order to make it readable by the route determiner 2.

The route determiner 2 is configured to communicate the initial route to the route provider 3, which causes the initial route to be provided to the user. For example, the route provider 3 may cause the initial route to be provided to the user in the form of visual or audible instructions output by output transducers 11 of the system 1. Examples of such output transducers 11 are described below.

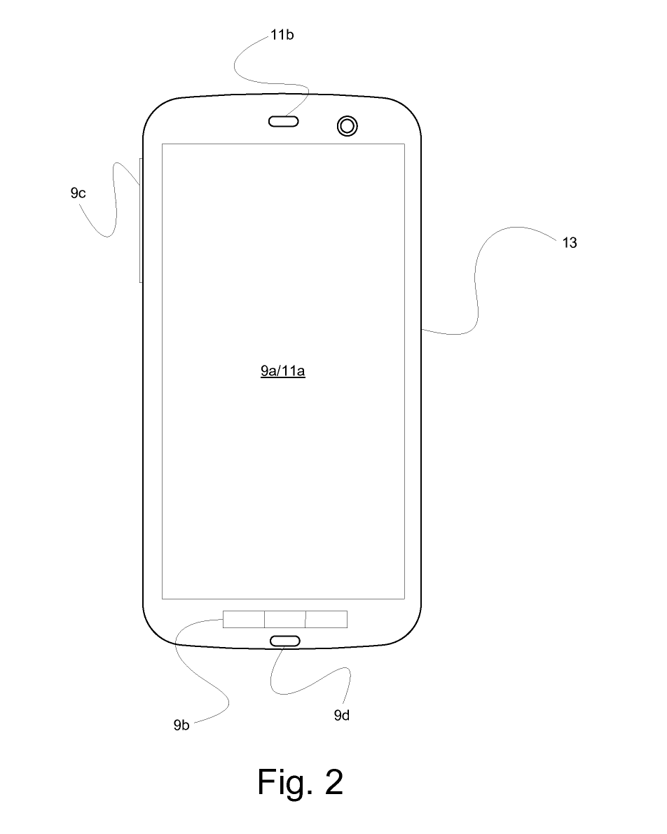

The location provider 4 is configured to monitor the location of the user and to report the location of the user to the route determiner 2 and the route provider 3. For example, the route provider 4 may comprise, or receive location information from, a GPS module 12 or other position-locating module 12 which is configured to determine the location of the user. More specifically, the position-locating module 12 may be configured to determine the location of an electronic device 13 which corresponds to the location of the user. Such a device 13 may be either inside or outside of the system 1, as will be explained further below, and may comprise the electronic apparatus 10 and/or software application 10 from which the route request may be received. The device 13 may be an electronic user device 13 and is illustrated in FIG. 2 as a smartphone, but it will be appreciated that the device 13 could alternatively be a large number of other types of device 13 such as a tablet computer, a laptop computer, a PDA, a satellite navigation device, a gaming console or a different type of mobile telephone. The device 13 may be portable, so that the user can carry it with him/her, and may be wearable, for example by being incorporated into clothing.

Location information provided by the location provider 4 describes the present location of the user, for example as a set of GPS coordinates. The route provider 3 may use this information to determine the appropriate moment to issue routing commands to the user so that, when the user is following the route, the commands which are output by the system 1 relate to parts of the route which the user is approaching. For example, the route provider 3 may be configured to issue turning commands when the user is a predetermined distance, such as approximately 500 m, from the turning in question. Similarly, other types of command, such as warning commands which warn of upcoming hazards on the route, may be issued when the user's approach distance to the hazard reaches a predetermined value.

In addition to being used by the route provider 3 to determine when to issue routing instructions, the location information provided by the location provider 4 may be used by the route determiner 2 to determine starting locations for alternative routes to the destination and/or may be used by the route provider 3 to determine when to prompt the user that such alternatives route(s) are available and are being approached.

The alternative routes may be determined by the route determiner 2 at any time during the user's journey from the starting location of the initial route to the destination. For example, the route determiner 2 may be configured to determine one or more alternative routes to the destination in response to the receipt of updated information about the available path network. This updated information may describe changes to the path network, including changes to the travelling conditions on the path network, which have occurred since the initial route was determined. Examples of such changes include changes in the amount or speed of traffic on a section of the path network, the occurrence or clearance of a road accident or other incident which at least partially blocks a section of the path network, and changes in weather conditions which affect the speed of traffic or which make following routes on various sections of the path network easier or more difficult. It will be appreciated that, in addition to the examples outlined above, there are a large number of other possible changes which might occur to affect the path network and that any of these changes might be included in the updated information which is received by the route determiner 2. The affected regions of the path network may include sections which form part of the initial route, and/or may be other sections of the network which potentially offer one or more alternatives to the initial route.

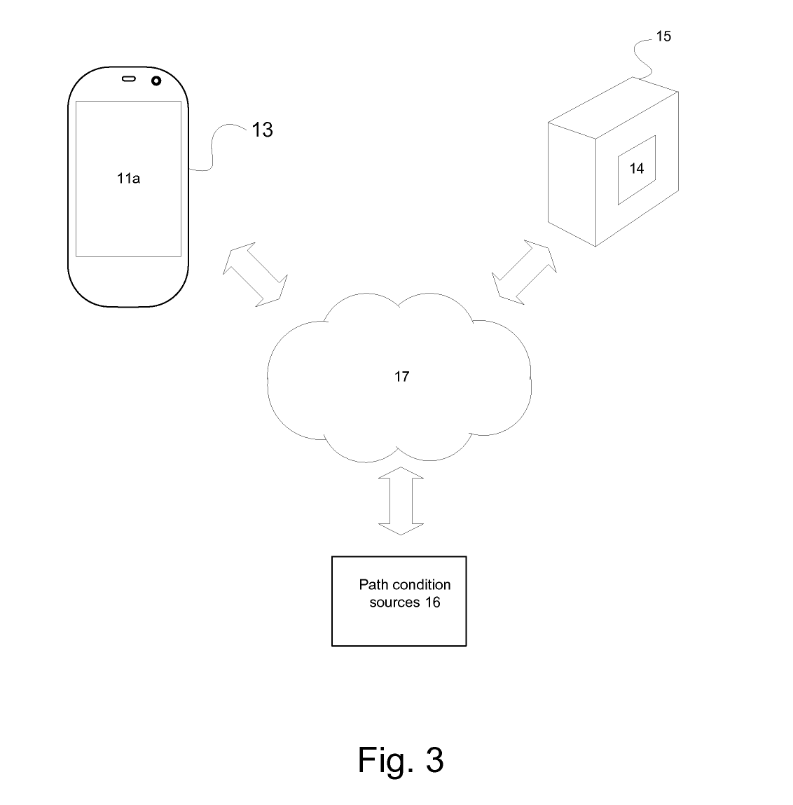

The updated information maybe received from a path conditions provider 14, which may be comprised either inside or outside of the route providing system 1. As with the route determiner 2, route provider 3 and location provider 4, the path conditions provider 14 may be implemented either in software, for example as one or more application programs, or in hardware. Referring to FIG. 3, for example, the path conditions provider 14 may be comprised in a computer apparatus 15 such as a server 15, or system 15 of distributed servers, which communicates updated information about the condition of the path network to the route determiner 2 at regular intervals. The server 15, or system 15 of servers, may be either inside or outside of the system 1.

The path conditions provider 14 may receive or otherwise collect information about one or more conditions of the path network from monitoring sources 16 which are located on the path network or which are otherwise arranged to collect travelling condition information directly from the path network. For example, the path conditions provider 14 may request the information at regular intervals or at predetermined times, or may be automatically sent the information at such intervals/times by the monitoring sources 16. The monitoring sources 16 may, for example, include traffic cameras and other watching devices which record the current traffic conditions and/or incidents and/or hazards on the paths. The monitoring sources 16 may also include weather monitoring devices which record the current weather on the path network. Such automatic monitoring sources 16 may be supplemented by users 16 on the path network, who may manually report travelling conditions to the path conditions provider 14 by electronic communication methods such as email and SMS.

As shown in FIG. 3, the path conditions provider 14 may be communicatively coupled to the path monitoring sources 16 by a communications coupling 17, such as an electronic communications network 17, so that information from the path monitoring sources 16 is transmitted to the path conditions provider 14 over the coupling 17. An example of such a communications coupling 17 is the Internet, but it will be appreciated that other types of electronic communications coupling 17 could alternatively be used. If the route providing system 1 comprises a distributed system 1 of electronic devices, as described in more detail further below, the communications coupling 17 may also communicatively connect together different device elements of the system 1 and thereby allow messages and information to be transmitted between the different system elements. In general, the coupling 17 may communicatively connect all device elements of the system 1 both to each other and to devices 13 and applications 10,14 which may be outside of the system 1.

In addition or as an alternative to determining alternative routes in response to receiving updated information about the path network, the route determiner 2 may be configured to determine alternative routes in response to other events. It will be appreciated that there are various possibilities for such events. An example is the elapse of a predetermined period of time since the user of the system 1 was last offered an alternative route by the route provider 3 or since the user started moving along the initial route.

The alternative routes which are determined by the route determiner 2 generally fall into one of two types. The first type of alternative route is one which is determined in accordance with the same route preference criteria as those which were used to determine the initial route. These routes generally offer an improvement on the initial route, due to changes in path conditions since the initial route was determined. For example, if the initial route was determined as being the fastest available route to the destination, the route determiner 2 may be configured to subsequently attempt to identify one or more alternative routes which offer an even faster journey to the destination. These alternative routes will generally be determined based on updated path information provided by the path conditions provider 14, such as information which indicates that the initial route has become heavy with traffic or which indicates that other parts of the path network which were previously heavy with traffic are now moving freely and so offer a faster route to the destination.

The second type of alternative route is one which is determined in accordance with different, or differently weighted, route preference criteria than the criteria which were used to determine the initial route. These routes generally offer a different type of journey to the initial route, such as a more scenic or otherwise enjoyable route as mentioned previously. The routes may be determined in accordance with updated path information from the path conditions provider 14 or maybe determined in response to other events, such as the approach of a scenic side turning which branches off the initial route.

The route provider 3 is configured to receive the alternative routes, or details describing the alternative routes, from the route determiner 2 and may cause the alternative routes to be provided to the user. This is described below as a two stage process in which the route provider 3 first causes the user to be prompted that an alternative route is available and secondly causes the alternative route to be provided to the user, for example in the form of routing instructions.

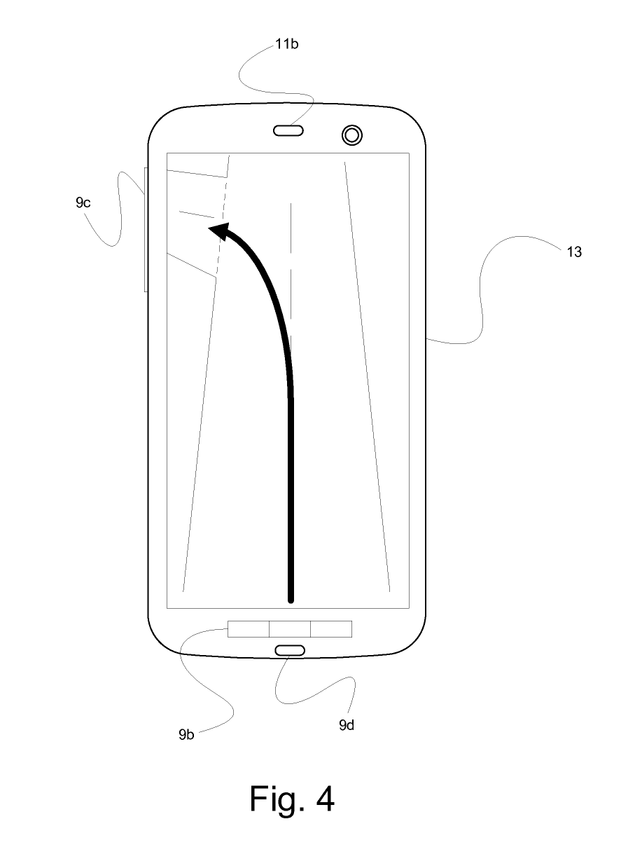

Referring to FIG. 4, upon an alternative route having been determined by the route determiner 2, the route provider 3 is configured to prompt the user of the system 1 that the alternative route is available and can be followed if the user so desires. The prompt may be issued through one or more of the system's output transducers 11. For example, the prompt may comprise a visual prompt, such as a visual indication on a display screen 11a of the electronic user device 13 referred to previously in relation to FIG. 2. The visual prompt may, for example, comprise a marking on a map or other type of navigation display which clearly indicates the location at which the alternative route branches off the initial route in the path network. The branching location may comprise the location of a turning off a path followed by the initial route, as shown in FIG. 4.

The prompt may additionally or alternatively comprise an audible prompt, which may be output by one or more loudspeakers 11b of the electronic user device 13. The audible prompt may take any suitable form, such as a ‘bleep’ or a spoken instruction, which informs the user of the availability of the alternative route and may indicate the location at which the alternative route branches off the initial route in the path network.

The prompt may additionally or alternative comprise other types of prompt, such as vibrational prompts issued by one or more vibration modules 11c in the electronic user device 13.

In addition to indicating the location at which the initial and alternative routes separate, the prompt may also provide other information about the attributes of the initial and alternative routes in order to help the user make an informed choice regarding which route to follow. For example, the prompt may include information which describes why the alternative route is being offered. This could be for any of the reasons previously mentioned, such as because it is faster, more scenic or less expensive than the route which the user is currently following.

The route provider 3 may be configured to issue the prompt to the user as the user approaches the location at which the alternative route branches off the initial route. The route provider 3 uses location information supplied by the location provider 4 in order to determine the appropriate moment to issue the prompt, for example in the manner previously described in relation to turning instructions and hazard warnings.

Having prompted the user that the alternative route is available, the routing system 1 is configured to automatically determine whether to supply routing instructions for the alternative route or whether to continue to supply routing instructions for the initial route. The route provider 3 makes this determination using user location information received from the location provider 4, which describes the current geographical location of the user on the path network. More specifically, the route provider 3 is configured to automatically determine from the user location information whether the user is located on the initial route or on the alternative route. The route provider 3 monitors the location of the user as the user approaches the branch point between the initial and alternative routes and, at the branch point, determines which of the routes most closely matches the location of the user. The route provider 3 may then continue to monitor the location of the user in order to verify that the route which was determined at the branch point is the route which the user is now following.

During this time, the route provider 3 continues to issue routing instructions which are relevant to whichever route the user has most recently been determined as following. If the user is determined as having changed routes, for example by leaving the initial route and joining the alternative route, the route provider 3 is configured to transition from providing routing instructions for the initial route to providing routing instructions for the alternative route.

In this way, the route providing system 1 is able to offer the user the opportunity to join the alternative route and, if the user elects to join the alternative route, to automatically provide routing instructions for the alternative route without the user needing to provide any commands to the system 1. The user is able to elect his/her desired route simply by progressing along his/her chosen, pre-calculated, route and is not required to take any other action, either in the form of touch or spoken inputs to the system 1 through its user interface 8 or in any other way. The user is able to focus his or her attention entirely on the path ahead, which increases the safety of the journey.

As with the prompts described above, the routing instructions may be issued in any suitable form and may comprise, for example, one or more visual, audible or vibrational messages. The route provider 3 may cause the routing instructions to be output by output transducers 11 of the system 1, such as the display screen 11a, loudspeakers 11b and vibration modules 11c referred to previously.

It will be understood that, although the routing process has been described above in terms of offering alternatives to an initial route, the process is actually applicable to any situation in which pre-calculated alternatives are available to the route which the user is currently following. The current route does not need to be the initial route which the user first started along, but can be any route along which the user is currently travelling. This includes routes which the system 1 previously offered as alternatives to a previous route and which the user elected to follow in favour of the previous route.

Furthermore, as will be apparent from the discussion of the example method below, although provision of alternative routes by the route provider 3 has been described as comprising a two stage process in which the route provider 3 first prompts the user as to the availability of an alternative route and subsequently tracks the location of the user in order to determine whether to provide routing instructions for the alternative route or whether to continue to provide routing instructions for the current route, the provision of alternative routes may comprise additional stages. An example of such an additional stage is a pre-stage in which the route provider 3 checks that the alternative route is in accordance with user preferences before prompting the user that the route is available. If the alternative route is not in accordance with such user preferences, then the route provider 3 may decline to prompt the user.

The user may input the route preferences into the route providing system 1 via the user interface 8 referred to above, for example using one or more of the input transducers 9. Examples of such input transducers 9 include one or more touch sensitive panels 9a, which maybe overlaid or otherwise associated with the display screen 11a, one or more touch sensitive keys 9b, one or more physical keys or other control buttons 9c and one or more microphones 9d. These are illustrated in FIG. 2 as being part of the electronic user device 13, along with the other output transducers 11b, 11c. The user preferences may be stored in the computer readable memory 7 of the system 1 and may restrict the types of alternative route which the user is prompted about. For example, the prompts may be restricted to those of only the first or second types referred to above, or may be restricted in any other way. In this way, the user is able to configure the system 1 to his/her liking.

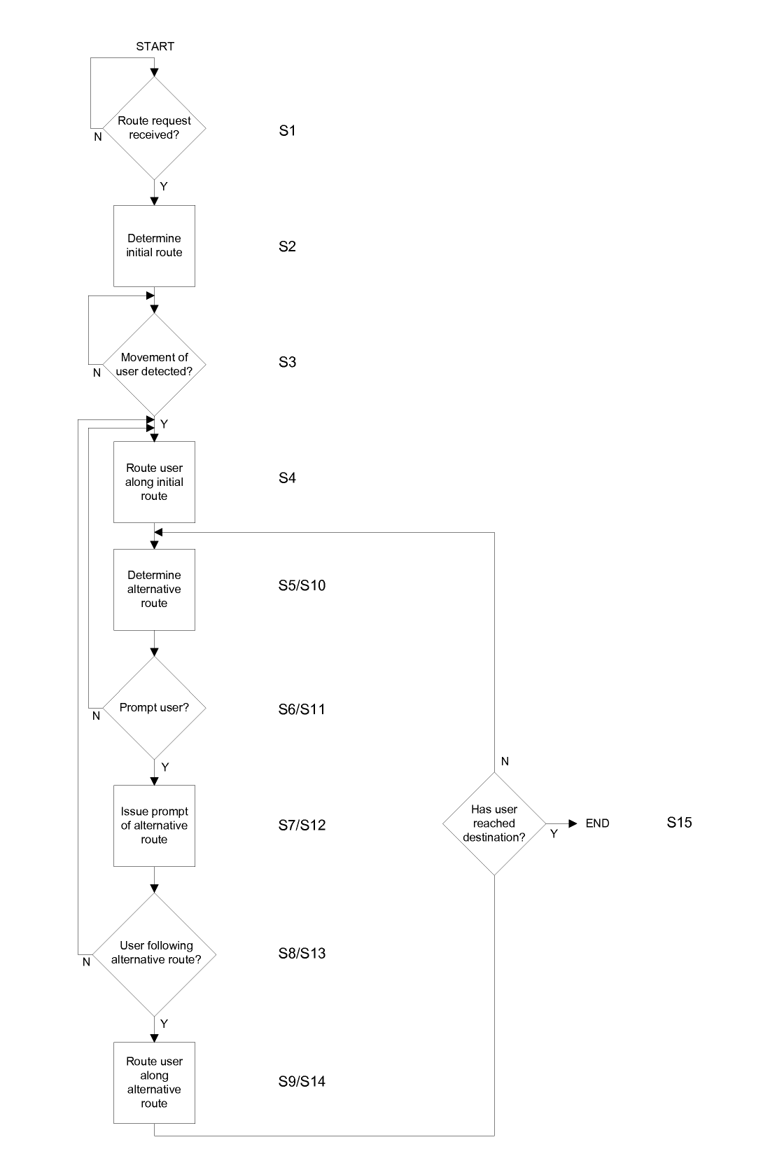

An example of a method of routing a user of the routing system 1 from a geographical starting location to a geographical destination location is described below in relation to FIG. 5. The method may comprise computer readable instructions, which may be in the form of computer program code, which are executable by a computer processor 18 of the system 1 in order to route the user to the destination. The computer readable instructions are stored in one or more computer readable memories 7 of the system 1. A computer architecture which is configured to store and implement the computer readable instructions, is described in more detail further below.

In a first step S1 of the method, the route providing system 1 receives a route request. This may be received either through a user interface 8 of the route providing system 1 or may be received from an external device over a communication coupling 17 as previously described.

In a second step S2 of the method, upon receipt of the route request, the route determiner 2 is configured to generate an initial route from a starting location to a destination specified in the route request. The starting location may be determined, from location information provided by the location provider 4, as the current location of the user of the system 1. Alternatively, the starting location may be specified in the route request as some other location. The route determiner 2 generates the route in the manner previously described, using data which describes a network of available paths and other data which describes conditions on the network. The route determiner 2 may also use other data included in the route request, such as a user preference for a specific type of route (e.g. fastest).

In a third step S3 of the method, the route provider 3 detects that the user has begun to move along the initial route. This detection of movement is made using location information provided to the route provider 3 by the location provider 4.

In a fourth step S4, the route provider 3 responds to the user's movement by causing routing instructions for the initial route to be issued to the user. The routing instructions may be provided in any suitable form, such as in the form of audible and/or visual instructions which guide the user along the route, as described previously, and may be issued by output transducers 11 located in the vicinity of the user either inside or outside of the route providing system 1.

In a fifth step S5 of the method, the route determiner 2 determines an alternative route to the destination. This determination may be made in response to an event such as the receipt of updated information about conditions on the available path network or the elapse of a predetermined period of time.

In a sixth step S6 of the method, the route provider 3 receives the alternative route determined by the route determiner 2, or at least information describing the alternative route, and determines whether to prompt the user that the alternative route is available. The determination as to whether to prompt the user may be made in accordance with preferences which the user has input into the route providing system 1, such as a preference to only be notified of alternative routes which offer a shorter journey time to the destination. If the route provider 3 determines not to prompt the user that the alternative route is available, it may continue to provide routing instructions for the current route until the route determiner 2 next determines that an alternative route is available.

In a seventh step S7 of the method, having determined to prompt the user that the alternative route is available, the route provider 3 causes such a prompt to be issued to the user. The prompt may take a visual, audible or any other suitable form and is issued to the user using output transducers 11 which may be comprised either inside or outside of the system 1.

In an eighth step S8 of the method, the route provider 3 automatically determines whether the user has elected to follow the alternative route or has elected to continue on the initial route. The route provider 3 does this by automatically monitoring the location and travelling direction of the user at the junction in the path network where the alternative route branches off the initial route, as previously described.

In a ninth step S9 of the method, the route provider 3 automatically causes routing instructions for the route which the user has been determined as following to be issued. These routing instructions may be issued in the same way as described above in relation to the fourth step S4 of the method in order to guide the user along the route.

The remaining discussion of the method refers to a situation in which the user elected to follow the alternative route and therefore one in which the route provider 3 ceased to issue routing instructions for the initial route and began issuing routing instructions for the alternative route. However, it will be appreciated that the following method steps are equally applicable to a situation in which the user elected to continue to follow the initial route and routing instructions continued to be issued for the initial route.

In a tenth step S10 of the method, the route determiner 2 determines another alternative route to the destination. This step S10 corresponds to the fifth step S5 discussed above and is carried out in the same manner.

In an eleventh step S11, the route provider 3 receives the alternative route determined by the route determiner 2, or at least information describing the alternative route, and determines whether to prompt the user that the alternative route is available. This step S11 corresponds to the sixth step S6 already discussed above and is carried out in the same manner. If the route provider 3 determines not to prompt the user that the alternative route is available, it may continue to provide routing instructions for the current route until the route determiner 2 next determines that an alternative route is available.

In a twelfth step S12, having determined to prompt the user that the alternative route is available, the route provider 3 causes such a prompt to be issued to the user. This step S12 corresponds to the seventh step S7 previously discussed.

In a thirteenth step S13, the route provider 3 automatically determines whether the user has elected to follow the alternative route or has elected to continue on the current route by automatically monitoring the location and travelling direction of the user at the junction in the path network where the alternative route branches off the initial route. This step S13 corresponds to the eighth step S8 previously discussed.

In an fourteenth step S14, the route provider 3 automatically causes routing instructions for the route which the user has been determined as following to be issued. This step corresponds to the ninth step S9 described previously.

The method repeats the tenth S10 to fourteenth S14 steps in a loop until the route provider 3 determines in a fifteenth step S15 that the user has arrived at the destination, at which time the route providing method ends. The route provider 3 determines that the user has arrived by using location information provided by the location provider 4 to detect that the location of the user corresponds to the location of the destination in the path network.

Referring back to FIGS. 1 to 3, the route providing system 1 may be comprised in one or more electronic devices 13, 15, which may include one or more electronic user devices 13 and one or more computer severs 15. The elements of the system 1, including the route determiner 2, the route provider 3 and the location provider 4, may be comprised within a single electronic device 13, 15 or may be distributed between different devices 13, 15. For example, all of the route determiner 2, the route provider 3 and the location provider 4 may be comprised in a single computer server 15 or in a single electronic user device 13. Alternatively, the route determiner 2 and the route provider 3 may be comprised in one or more routing servers 15 whilst the location provider 4 is comprised in a separate user device 13. Alternatively, the route determiner 2 may be comprised in one or more routing servers 15 whilst the route provider 3 and the location provider 4 are comprised in a separate user device 13. It will be appreciated that other combinations are also possible.

Likewise, other elements of the system 1 such as the controller 5, the one or more computer readable memories 7 and the one or more computer processors 18 may be comprised either in one or more servers 15 or in an electronic user device 13.

Other elements referred to above are in close proximity to the user and may therefore be comprised in the electronic user device 13. These elements include the user interface 8, input transducers 9, route requester 10, output transducers 11 and position locating module 12. If the electronic device 13 is not part of the system 1 but is instead used by the system 1 to collect information and to deliver prompts and instructions to the user, then these elements may be outside of the system 1. Such elements also include the path conditions provider 14, which may reside in a computer server 15 or in another electronic device 13 which is either inside or outside of the system 1.

If the system 1 comprises a plurality of devices 13, 15, then the devices 13, 15 may communicate with one another using the communication coupling 17 previously described. The devices 13, 15 may, for example, each be equipped with one or more communication apparatuses 19, which may comprise one or more electronic signal inputs and outputs, such as one or more suitable ports and/or antennas, and transceiver circuitry for sending and receiving data.

Each device 13, 15 may also comprise a power supply 20 configured to supply power to components of the device 13, 15. For example, the power supply 20 may be configured to couple to a mains power supply, or central vehicle power supply, so as to supply power to the device components. Additionally or alternatively, the power supply 20 may comprise a re-chargeable energy source 20, such as a battery or fuel cell, which can be coupled to another power supply for re-charging.

Some portions of the above description present the features of the invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, the reference to these arrangements of operations in terms of modules should not be considered to imply a structural limitation and references to functional names is by way of illustration and does not infer a loss of generality.

Unless specifically stated otherwise as apparent from the description above, it is appreciated that throughout the description, discussions utilising terms such as “processing” or “identifying” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the invention include process steps and instructions described herein in the form of an algorithm. It should be understood that the process steps, instructions, of the invention as described and claimed, are executed by computer hardware operating under program control, and not mental steps performed by a human. Similarly, all of the types of data described and claimed are stored in a computer readable storage medium operated by a computer system, and are not simply disembodied abstract ideas.

The invention also relates to an apparatus for performing the operations herein. This apparatus may be specially constructed for the required purposes, or it may comprise a general-purpose computer selectively activated or reconfigured by a computer program stored on a computer readable medium that can be executed by the computer. Such a computer program is stored in a computer readable storage medium 7 which may be, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), flash memory, or any type of media suitable for storing electronic instructions, and each coupled to a computer system bus. Furthermore, the processor 18 referred to in the specification may be a single processor or may be one or more architectures employing multiple processor designs for increased computing capability.

The controller 5 referred to above may take any suitable form. For instance, the controller 5 may comprise processing circuitry, including the one or more processors 18, and the memory device 7, comprising a single memory unit or a plurality of memory units. The memory devices 7 may store computer program instructions that, when loaded into processing circuitry, control the operation of the system 1. The computer program instructions may provide the logic and routines that enable the system 1 to perform the functionality described above. For example, the computer processor(s) 18 may operate under the control of the computer program instructions in order to cause the system 1 to automatically determine which of the alternative routes the user has elected to follow and to automatically cause route instructions for the elected route to be output to the user. The computer program instructions may arrive at the system 1 via an electromagnetic carrier signal or be copied from a physical entity such as a computer program product, a non-volatile electronic memory device (e.g. flash memory) or a record medium such as a CD-ROM or DVD. Typically, the processor(s) 18 of the controller(s) 5 are coupled to both volatile memory and non-volatile memory. The computer program is stored in the non-volatile memory and is executed by the processor(s) 18 using the volatile memory for temporary storage of data or data and instructions. Examples of volatile memory include RAM, DRAM, SDRAM etc. Examples of non-volatile memory include ROM, PROM, EEPROM, flash memory, optical storage, magnetic storage, etc. The terms ‘memory’, ‘memory medium’ and ‘storage medium’ when used in this specification are intended to relate primarily to memory comprising both non-volatile memory and volatile memory unless the context implies otherwise, although the terms may also cover one or more volatile memories only, one or more non-volatile memories only, or one or more volatile memories and one or more non-volatile memories.

The algorithms and operations presented herein can be executed by any type or brand of computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the invention is not described with reference to any particular programming language. It is appreciated that a variety of programming languages may be used to implement the teachings of the invention as described herein.

1. A computer implemented method of routing a user to a destination, comprising:
routing, by one or more computing devices, the user towards the destination along an initial route, the initial route comprising an expected duration and being determined based at Least in part on a time to travel between an origin and a destination
prompting the user, by the one or more computing devices, that an alternative route to the destination is available wherein the alternative route comprises an expected duration and is Determined in accordance with differently weighted route preference criteria than the initial route Between the origin and the destination, the alternative route being prompted to the user Irrespective of whether the expected duration of the alternative route is greater than the expected Duration of the initial route; and
monitoring the location of the user, by the one or more computing devices, to determine whether to provide routing directions for the initial route or for the alternative route.

2. A computer implemented method according to claim 1, comprising determining the location of the user from user location information provided by an electronic user device.

3. A computer implemented method according to claim 1, comprising automatically determining from the location of the user whether the user has elected to follow the alternative route or has elected to continue to follow the initial route.

4. (canceled)

5. A computer implemented method according to claim 1, comprising automatically providing the user with routing instructions for the alternative route in response to determining that the user is following the alternative route.

6. A computer implemented method according to claim 1, comprising automatically providing the user with routing instructions for the initial route in response to determining that the user is following the initial route.

7. A computer implemented method according to claim 1, comprising automatically stopping routing the user along the initial route and starting routing the user along the alternative route in response to determining that the user is located on the alternative route.

8. A computer implemented method according to claim 1, comprising prompting the user by issuing an audible prompt.

9. A computer implemented method according to claim 1, comprising prompting the user by issuing a visual prompt.

10. A computer implemented method according to claim 1, comprising prompting the user that the alternative route is available whilst simultaneously routing the user along the initial route.

11. A computer implemented method according to claim 1, comprising routing the user by issuing audible or visual instructions.

12. (canceled)

13. A computer implemented method according to claim 12, comprising determining the alternative route in response to receiving updated information about travelling conditions on the initial route.

14. A computer implemented method according to claim 12, comprising determining the alternative route in response to receiving updated information about travelling conditions on the alternative route.

15. A computer implemented method according to claim 13, wherein the updated information comprises updated traffic information.

16. (canceled)

17. An apparatus comprising at least one computer processor and at least one computer memory storing instructions which when executed by the at least one processor cause the apparatus to:
route a user towards a destination along an initial route, the initial route comprising an expected duration and being determined based at least in part on a time to travel between an origin and the destination;
prompt the user that an alternative route to the destination is available, wherein the alternative route comprises an expected duration and is determined in accordance with differently weighted route preference criteria than the initial route between the origin and the destination, the alternative route being prompted to the user irrespective of whether the expected duration of the alternative route is greater than the expected duration of the initial route; and
monitor the location of the user to determine whether to provide routing directions for the initial route or for the alternative route.

18. An apparatus according to claim 17, wherein the instructions cause the apparatus to determine the location of the user from user location information provided by an electronic user device.

19. An apparatus according to claim 17, wherein the instructions cause the apparatus to automatically determine from the location of the user whether the user has elected to follow the alternative route or has elected to continue to follow the initial route.

20. (canceled)

21. An apparatus according to claim 17, wherein the instructions cause the apparatus to automatically provide the user with routing instructions for the alternative route in response to determining that the user is following the alternative route.

22. An apparatus according to claim 17, wherein the instructions cause the apparatus to automatically provide the user with routing instructions for the initial route in response to determining that the user is following the initial route.

23. An apparatus according to claim 17, wherein the instructions cause the apparatus to automatically stop routing the user along the initial route and start routing the user along the alternative route in response to determining that the user is located on the alternative route,

24. An apparatus according to claim 17, wherein the instructions cause the apparatus to prompt the user that the alternative route is available whilst simultaneously routing the user along the initial route.

25. (canceled)

26. An apparatus according to claim 17, wherein the instructions cause the apparatus to determine the alternative route in response to receiving updated information about travelling conditions on the initial route.

27. (canceled)

28. A system for routing a user from a starting location to a destination location, comprising at least one computer processor and at least one computer memory storing computer readable code which when executed by the at least one processor causes the system to:
route the user towards the destination along an initial route, the initial route comprising an expected duration and being determined based at least in part on a time to travel between the starting location and the destination;
prompt the user that an alternative route to the destination is available, wherein the alternative route comprises an expected duration and is determined in accordance with differently weighed route preference criteria than the initial route between the starting location and the destination, the alternative being prompted to the user irrespective of whether the expected duration of the alternative route is greater than the expected duration of the initial route; and
monitor the location of the user to determine whether to provide routing directions for the initial route or for the alternative route.

29. A computer program product comprising non-transitory computer readable instructions which when executed by at least one computer processor cause an apparatus to route a user from a starting location to a destination location by:
routing the user towards the destination along an initial route, the initial route comprising an expected duration and being determined based at least in part on a time to travel between the starting location and the destination;
prompting the user that an alternative route to the destination is available, wherein the alternative route comprises an expected duration and is determined in accordance with differently weighed route preference criteria than the initial route between the starting location and the destination, the alternative being prompted to the user irrespective of whether the expected duration of the alternative route is greater than the expected duration of the initial route, and
monitoring the location of the user to determine whether to provide routing directions for the initial route or for the alternative route.
